(19) United States
(12) Patent Application Publication
(10) Pub. No.: US 2026/0268461 A1
(43) Pub. Date: Sep. 10, 2026

(54) IMAGING APPARATUS, IMAGING METHOD, AND RECORDING MEDIUM

(71) Applicant: CANON KABUSHIKI KAISHA, Tokyo (JP)

(72) Inventor: TSUTOMU TAKADA, Kanagawa (JP)

(21) Appl. No.: 19/543,749

(22) Filed: Feb. 18, 2026

(30) Foreign Application Priority Data
Mar. 4, 2025 (JP) 2025-033590

(51) Int. Cl. G06T 5/80; G06T 5/50; H04N 25/61

(52) U.S. Cl. CPC G06T 5/80; G06T 5/50; H04N 25/61; G06T 2207/20212; G06T 2207/30252

(57) ABSTRACT

An imaging apparatus includes an imaging unit configured to sequentially output a first frame image and a second frame image, a first image processing unit configured to execute image processing on image data of a first region of each frame image, a second image processing unit configured to execute image processing on image data of a second region of the each frame image, and an image combining unit configured to combine the image data of the first region processed by the first image processing unit and the image data of the second region processed by the second image processing unit. The image combining unit combines a result of executing the image processing on the second frame image by the first image processing unit and a result of executing the image processing on the first frame image by the second image processing unit to generate a corrected frame image.

### BACKGROUND

### Field of the Technology

The present disclosure relates to an imaging apparatus, an imaging method, and the like for correcting and outputting a captured image.

### Description of the Related Art

As wearable devices including a display apparatus, for example, devices called a head mounted display (HMD) and smart glasses are known. For such wearable devices, there is known a method in which an imaging apparatus captures, as an image, a scene in front of eyes of a user (a scene of the outside world) and displays the image on a display device. If the image is appropriately displayed, the user can feel as if the user is directly viewing the scene of the outside world even though the user is viewing the scene through the display device.

In addition, there is also known a device that supports a driving operation by displaying an image captured by an imaging apparatus mounted on a mobile body such as a vehicle to a user, or controls movement of the vehicle or the like by performing recognition on the captured image.

By the way, it is known that an imaging lens used in the imaging apparatus has a distortion aberration characteristic. In the imaging apparatus provided in the wearable device, the mobile body, or the like, a wide-angle imaging lens is used to capture an image of the surroundings of the user in a wide visual field, but the wide-angle imaging lens has an optical characteristic that distortion aberration increases at a peripheral portion of a screen. When distortion occurs in the image captured by the imaging apparatus, the user of the wearable device or the mobile body cannot correctly recognize a shape or position of an imaged object, which may be a problem.

In order to correct image distortion due to distortion aberration of the imaging lens, JP 2008-65722 A discloses a device that writes captured image data in an image memory, then reads the image data from the image memory, executes image processing (distortion correction processing), and displays the image data with the distortion corrected.

The processing device described in JP 2008-65722 A executes distortion correction processing according to an optical distortion characteristic. However, when a load of the correction processing is large, there may be cases where the processing is not completed in time for a display timing of a corresponding image frame.

In this case, in the device of JP 2008-65722 A, the image is displayed at a timing of a subsequent image frame, or the image is displayed at a lowered frame rate in a plurality of subsequent frame periods. For this reason, a situation occurs in which a large delay time occurs until the captured image is displayed, or the frame rate of the image to be displayed is lowered.

For example, in the case of the wearable device, when a delay time from imaging of a subject in the outside world to display of an image of the subject increases, it takes time for the user to recognize the surrounding situation, and there is a possibility that the user stumbles or collides with the object, for example. In addition, when the user changes his/her face orientation, the display image lags behind, which causes the user to feel discomfort. Also, in a case where the frame rate of the display image is lowered, a moving image is not smoothly displayed, and thus, there is a high possibility that the user cannot accurately recognize the situation.

Furthermore, also in the case of the imaging apparatus mounted on the mobile body such as the vehicle, a safety problem may occur due to, for example, a delay in display of an image obtained by imaging the surroundings to a driver due to the distortion correction processing, or a delay in recognition of a surrounding object due to the distortion correction processing.

Therefore, there has been a demand for a technology capable of effectively correcting distortion of a captured image that adversely affects user visibility without excessively increasing a time required from imaging to display.

### SUMMARY

According to a first aspect of the present disclosure, an imaging apparatus includes an imaging unit configured to sequentially output a first frame image and a second frame image, the first frame image and the second frame image being obtained by continuously capturing an optical image incident through an imaging optical system, a first image processing unit configured to execute image processing on image data of a first region of each frame image output by the imaging unit, a second image processing unit configured to execute image processing on image data of a second region of the each frame image output by the imaging unit, and an image combining unit configured to combine the image data of the first region processed by the first image processing unit and the image data of the second region processed by the second image processing unit. A time required for the image processing per frame image is longer in the second image processing unit than in the first image processing unit. The image combining unit is configured to combine a result of executing the image processing on the second frame image by the first image processing unit and a result of executing the image processing on the first frame image by the second image processing unit to generate a corrected frame image.

According to a second aspect of the present disclosure, an imaging method includes an imaging step of sequentially outputting, by an imaging unit, a first frame image and a second frame image, the first frame image and the second frame image being obtained by continuously capturing an optical image incident through an imaging optical system, a first image processing step of executing, by a first image processing unit, image processing on image data of a first region of each frame image output by the imaging unit, a second image processing step of executing, by a second image processing unit, image processing on image data of a second region of the each frame image output by the imaging unit, and an image combining step of combining, by an image combining unit, the image data of the first region processed by the first image processing unit and the image data of the second region processed by the second image processing unit. A time required for the image processing per frame image is longer in the second image processing step than in the first image processing step. In the image combining step, a result of executing the image processing on the second frame image by the first image processing unit and a result of executing the image processing on the first frame image by the second image processing unit are combined to generate a corrected frame image.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic block diagram showing an overall configuration of an imaging apparatus according to a first embodiment.

FIG. 2 is a schematic block diagram showing a configuration of a distortion correction unit included in a peripheral image processing unit.

FIG. 3A is a view showing a grid-like subject.

FIG. 3B is a view showing an image obtained by imaging the subject in FIG. 3A using an optical system with distortion aberration.

FIG. 4A is a view showing a center region and a peripheral region that are set in advance.

FIG. 4B is a schematic diagram showing a procedure of transferring image data to a center region image processing unit and a peripheral region image processing unit.

FIG. 5 is a time chart schematically showing timings of steps of processing executed in time series by respective units in the first embodiment.

FIG. 6 is a schematic diagram showing a procedure of separating captured image data into image data of a center region and image data of a peripheral region and outputting the separated pieces of image data in a second embodiment.

FIG. 7 is a time chart schematically showing timings of steps of processing executed in time series by respective units in the second embodiment.

FIG. 8 is a schematic block diagram showing an overall configuration of an imaging apparatus according to a third embodiment.

FIG. 9 is a diagram showing view angles at which a center imaging unit and a peripheral imaging unit perform imaging.

FIG. 10A is a schematic diagram showing a procedure of transferring image data of a center region to a center image processing unit.

FIG. 10B is a schematic diagram showing a procedure of transferring image data of a peripheral region to a peripheral image processing unit.

FIG. 11 is a time chart schematically showing timings of steps of processing executed in time series by respective units in the third embodiment.

FIG. 12A is a schematic diagram for describing equipment according to a fourth embodiment.

FIG. 12B is a diagram showing an example of a photoelectric conversion system related to an in-vehicle camera.

FIG. 12C is a diagram showing the photoelectric conversion system in the case of imaging an area in front of a vehicle.

### DESCRIPTION OF THE EMBODIMENTS

An imaging apparatus, an imaging method, and the like according to embodiments of the present disclosure will be described with reference to the drawings. The embodiments described below are merely examples, and for example, detailed configurations can be appropriately changed and implemented by those skilled in the art without departing from the gist of the present disclosure.

In the drawings referred to in the following embodiments and description, elements denoted by the same reference numerals have similar functions unless otherwise specified. In the drawings, in a case where a plurality of the same elements are arranged, reference numeral and a description thereof may be omitted.

In addition, the drawings may be schematic for convenience of illustration and description, and thus, the shape, size, arrangement, and the like of elements in the drawings may not strictly match those of actual ones.

The present embodiment is implemented based on the knowledge of the present inventor that a computation time required for distortion correction processing for a peripheral region is long since the amount of distortion is larger in the peripheral region of a display image than in the vicinity of a center portion, but visual sensitivity of a user is low for the peripheral region. That is, in general, in an imaging apparatus mounted on a wearable device or a mobile body such as a vehicle, an imaging lens having a relatively large view angle is used to image the surroundings in a wide range. For example, a lens having a wide view angle, such as a wide-angle lens or a fisheye lens, has an optical characteristic in which the amount of distortion is small at a center portion of a screen, but increases toward a peripheral portion of the screen. When distortion correction is performed on a captured image, a computation amount is large for the peripheral portion having a large distortion amount, and a processing time per frame image for the peripheral portion is longer than that for the center portion. Since a long time is required for correction processing for the peripheral portion, image processing for one screen is not completed in time for a frame rate of a display apparatus, as a result of which a delay time from imaging to display increases, or a delay from imaging to display is accumulated unless frame skipping is performed, for example.

On the other hand, according to visual characteristics of human eyes, in the display screen of the wearable device such as a head mounted display (HMD) or the mobile body such as the vehicle, the visual sensitivity of the user is high in the vicinity of the center portion of the display screen gazed at by the user, but the visual sensitivity of the user is low for the peripheral region.

Therefore, in the embodiment, the vicinity of the center portion of the display screen where the visual sensitivity of the user is high but the computation time required for the distortion correction processing is short, and the peripheral portion where the visual sensitivity of the user is low but the computation time required for the distortion correction processing is long are handled separately. Then, image data of the vicinity of the center portion subjected to the distortion correction processing of the N-th frame and image data of the vicinity of the peripheral portion subjected to the distortion correction processing of the N-1-th frame are combined (image combining step) and displayed. The delay time from imaging to display is shortened for the vicinity of the center portion of the display screen where the visual sensitivity of the user is high, and the peripheral portion of the display screen where the visual sensitivity of the user is low and a longer time is required for the distortion correction processing is displayed in a subsequent frame. As specifically described below, there is provided a technology advantageous for effectively correcting distortion of a captured image that adversely affects visibility of the user without excessively increasing a time required from imaging to display.

### First Embodiment

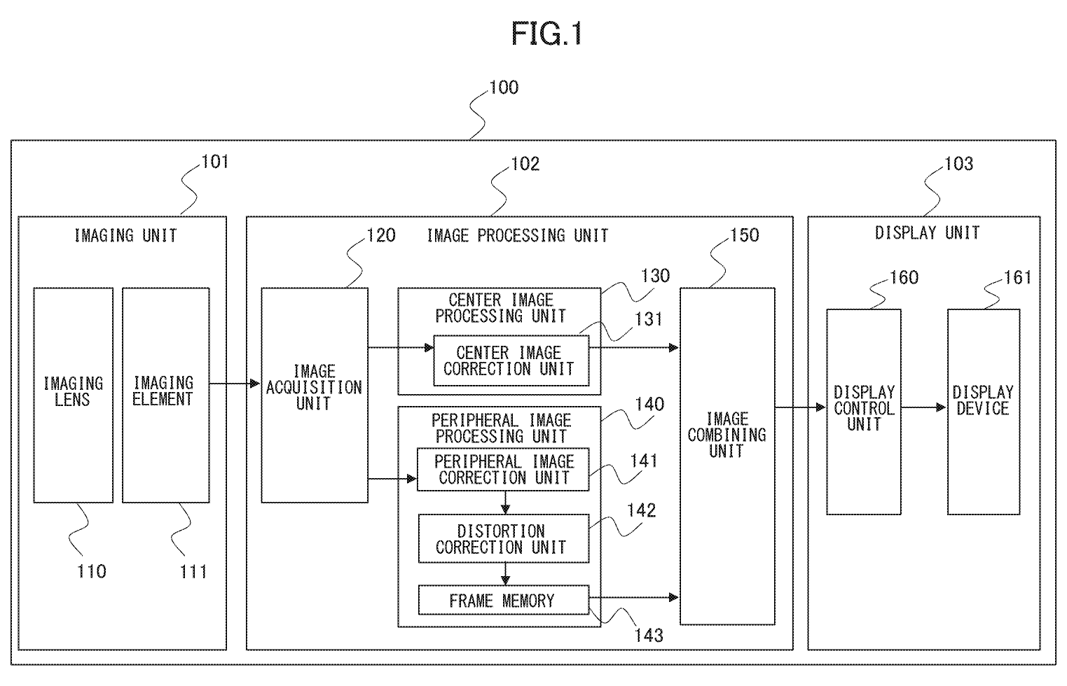

A first embodiment will be described with reference to FIGS. 1 to 5. FIG. 1 is a schematic block diagram showing an overall configuration of an imaging apparatus 100 according to the first embodiment. As shown in FIG. 1, the imaging apparatus 100 includes an imaging unit 101, an image processing unit 102, and a display unit 103, and displays an image captured by an imaging device on a display device. In a case where the imaging apparatus is applied to a head mounted display, left-eye image data and right-eye image data can be generated by using the imaging apparatus in each of units for the left eye and the right eye, and displayed on display units.

The imaging unit 101 includes an imaging lens 110 serving as an imaging optical system and an imaging element 111. A subject image focused by the imaging lens 110 is formed on a light receiving surface of the imaging element 111, and is photoelectrically converted by the imaging element 111 to acquire image data (imaging step).

The imaging lens 110 can be configured to form a high-resolution region having a high optical imaging magnification at a small view angle corresponding to a center portion (center region) of a visual field centered on an optical axis, and to form a low-resolution region having a low imaging magnification at a large view angle corresponding to a peripheral portion (peripheral region) of the visual field.

In the imaging element 111, the subject image formed on the light receiving surface by the imaging lens 110 is exposed for each frame, the image data is acquired by photoelectric conversion, and the image data is output as an electric signal. As the imaging element 111, an image sensor in which a plurality of pixels are two-dimensionally arranged on a light receiving surface such as a complementary metal-oxide-semiconductor (CMOS) sensor, a charge-coupled device (CCD) sensor, or a single photon avalanche diode (SPAD) sensor can be applied. The imaging unit can sequentially output a first frame image and a second frame image obtained by continuously capturing an optical image incident through the imaging optical system.

As described above, with the imaging optical system in which the imaging magnification varies depending on the view angle, it is possible to capture a clear high-resolution image for the center region corresponding to a small view angle where visual sensitivity of a user is high, and capture a low-resolution image over a wide range for the peripheral region where the visual sensitivity of the user is low. However, in the imaging lens 110 in which the imaging magnification varies depending on the view angle as described above, optical distortion (distortion aberration) occurs in the image to be formed, whereby a distorted image is generated in the imaging element 111.

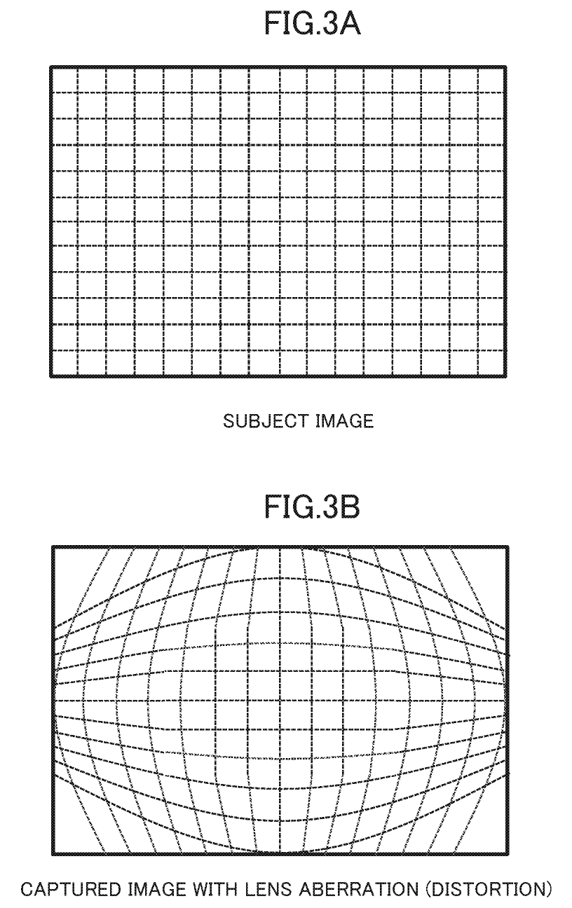

FIGS. 3A and 3B are diagrams for showing a relationship between a subject and a captured image. FIG. 3A shows a grid-shaped subject, and FIG. 3B shows an image obtained by capturing the subject of FIG. 3A via an optical system with distortion aberration. As is clear from both FIGS. 3A and 3B, the captured image acquired by the imaging element 111 through the imaging lens 110 with distortion aberration is a distorted image in which a distortion increases toward the peripheral region. Such an image distortion is subjected to correction processing in a distortion correction unit 142 (FIG. 1) as described below.

Next, the image processing unit 102 included in the imaging apparatus 100 will be described. As shown in FIG. 1, the image processing unit 102 includes an image acquisition unit 120, a center image processing unit 130 (first image processing unit), a peripheral image processing unit 140 (second image processing unit), and an image combining unit 150, and executes image processing on the image data received from the imaging unit 101.

The image acquisition unit 120 performs an image acquisition step. That is, the image data captured at an imaging timing for each frame is acquired from the imaging unit 101. Then, the image data of the center region (first region) is output to the center image processing unit 130, and the image data of the peripheral region (second region) is output to the peripheral image processing unit 140 according to region designation set in advance.

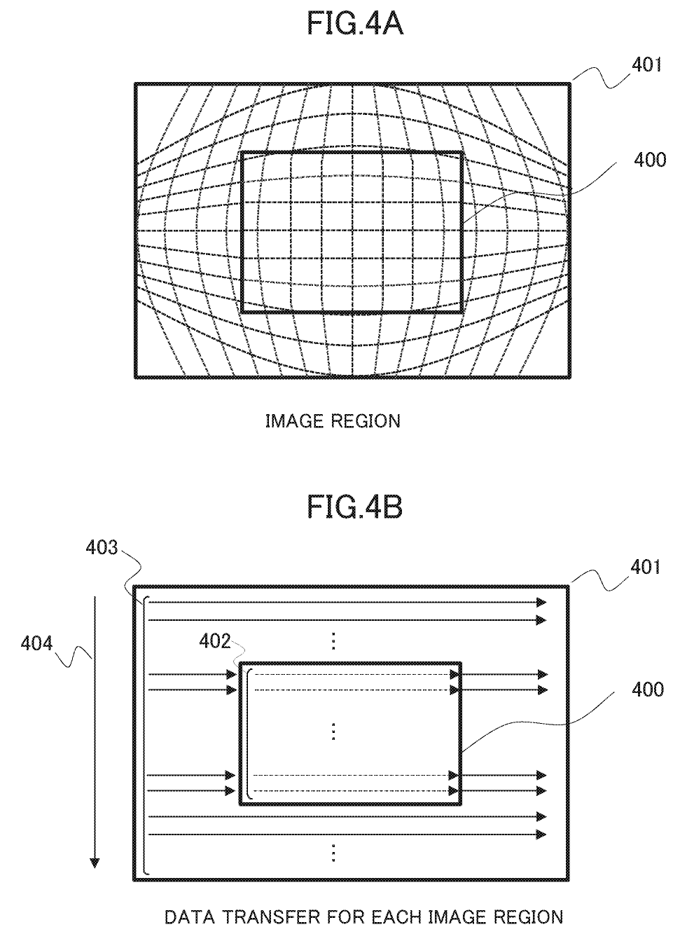

FIG. 4A shows a center region 400 (first region) and a peripheral region 401 (second region) that are set in advance. The center region 400 is a region having a high imaging magnification, a high resolution, and a small image distortion, and the peripheral region 401 is a region positioned outside the center region 400 and having a low resolution and a large image distortion. That is, the second region is a region in which an amount of distortion due to the distortion aberration of the imaging optical system is larger than that in the first region. It may be said that the image data of the first region is image data obtained by capturing an image within a range of a predetermined view angle centered on the optical axis of the imaging optical system, and the image data of the second region includes image data obtained by capturing an image corresponding to a range of a view angle larger than the predetermined view angle.

FIG. 4B is a schematic diagram for showing a procedure of transferring, by the image acquisition unit 120, the pieces of acquired image data of the frame images to the center image processing unit 130 and the peripheral image processing unit 140. A horizontal arrow indicates horizontal scanning in the data transfer, and a vertical arrow 404 indicates vertical scanning in the data transfer.

The image acquisition unit 120 outputs image data 402 of the center region 400 to the center image processing unit 130, and outputs image data 403 of the peripheral region 401 to the peripheral image processing unit 140 in a separated manner while receiving the raster-scanned image data line by line from the imaging unit 101. In the example of FIG. 4B, the center region 400 and the peripheral region 401 are set exclusively such that there is no overlapping portion. However, the center region 400 and the peripheral region 401 may be set such that a part of the center region 400 and a part of the peripheral region 401 overlap each other. The image data 402 of the center region 400 of the frame image is output in an order indicated by a dotted arrow, and the image data 403 of the peripheral region 401 is output in an order indicated by a solid arrow.

As shown in FIG. 1, the center image processing unit 130 includes a center image correction unit 131. The center image correction unit 131 executes correction processing related to a characteristic of the imaging element 111 and correction processing related to an optical characteristic of the imaging lens 110 (first image processing step). Examples of the correction related to the characteristic of the imaging element 111 include scratch correction and dark correction, but other types of correction may also be performed. Examples of the correction related to the optical characteristic of the imaging lens 110 include vignetting correction for compensating for a decrease in light intensity of a peripheral view angle region, and chromatic aberration correction for compensating for chromatic aberration of the lens, but other types of correction may also be performed. The image data of the center region 400 subjected to the correction processing by the center image correction unit 131 is output to the image combining unit 150.

The peripheral image processing unit 140 includes a peripheral image correction unit 141, a distortion correction unit 142, and a frame memory 143, and performs a second image processing step. That is, similarly to the center image correction unit 131, the peripheral image correction unit 141 performs correction related to the characteristic of the imaging element 111 and correction related to the optical characteristic of the imaging lens 110 on the image data 403 of the peripheral region, and outputs a result to the distortion correction unit 142 in a downstream stage.

The distortion correction unit 142 executes correction processing for the distortion that occurs in the image data due to the distortion aberration of the imaging lens 110, and stores the corrected image data (processing result) in the frame memory 143 that can store the image data (distortion correction processing). The corrected image data of the peripheral region 401 is output from the frame memory 143 to the image combining unit 150 in response to a read request from the image combining unit 150.

When the image data of the center region 400 of the current frame processed by the center image processing unit 130 is received, the image combining unit 150 reads the image data of the peripheral region 401 of the immediately preceding frame stored in the frame memory 143 of the peripheral image processing unit 140. Then, the image data of the center region 400 of the current frame and the image data of the peripheral region 401 of the immediately preceding frame are combined to generate a display image (corrected frame image) of one frame, and the display image is output to the display unit 103. At this time, the image combining unit 150 may execute the image processing such as blending on pixels in the vicinity of a boundary between the center region 400 and the peripheral region 401 to generate the corrected frame image (by combination).

The display unit 103 includes a display control unit 160 and a display device 161. The display control unit 160 outputs the image data received from the image processing unit 102 to the display device 161 for each frame according to a display timing of the display device 161. The display device 161 can be implemented by, for example, a small liquid crystal display (LCD) or an organic light emitting diode (OLED) display. The display device 161 displays an image for each frame based on the image data and a display timing control signal supplied from the display control unit 160.

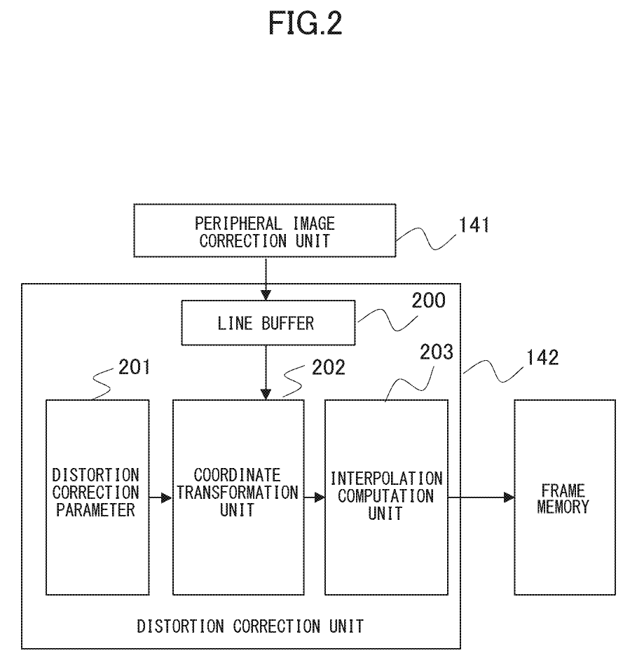

FIG. 2 is a schematic block diagram showing a configuration of the distortion correction unit 142 included in the peripheral image processing unit 140. A line buffer 200 is a buffer memory for storing the image data corresponding to the number of lines to be used for performing distortion correction. For example, the line buffer 200 is configured to store, in a case where one horizontal line included in the subject is distorted due to a distortion characteristic of the imaging lens 110, and imaging is performed across a plurality of pixel rows (lines) arranged in a vertical direction of the imaging element, the image data corresponding to at least the number of lines across the plurality of pixel rows (lines). In other words, the line buffer 200 can store the image data of the peripheral image corresponding to the number of lines including the maximum amount of distortion in the vertical direction.

A distortion correction parameter 201 is information indicating the distortion characteristic of the imaging lens 110 at each pixel position in the peripheral region, and includes a mathematical expression indicating the distortion characteristic, a look-up table (LUT) in which coordinates of the distorted image are associated with each pixel, or the like.

A coordinate transformation unit 202 calculates, based on information regarding the distortion correction parameter 201, a coordinate position of the distorted image stored in the line buffer 200 in association with a coordinate position of a display image to be displayed on the display device 161. Then, the coordinate transformation unit 202 reads a plurality of pieces of pixel data in the vicinity of the calculated coordinate position from the line buffer 200, and outputs the plurality of pieces of pixel data to an interpolation computation unit 203 in a downstream stage together with information regarding the coordinate position.

In order to obtain pixel data corresponding to the coordinate position of the display image, the interpolation computation unit 203 performs interpolation computation by using the plurality of pieces of pixel data output from the coordinate transformation unit 202. For the interpolation computation, for example, a method such as nearest-neighbor interpolation, bilinear interpolation, or bicubic interpolation can be used. Display image data obtained as a result of the interpolation computation is stored in the frame memory 143 in association with the coordinate position of the display image.

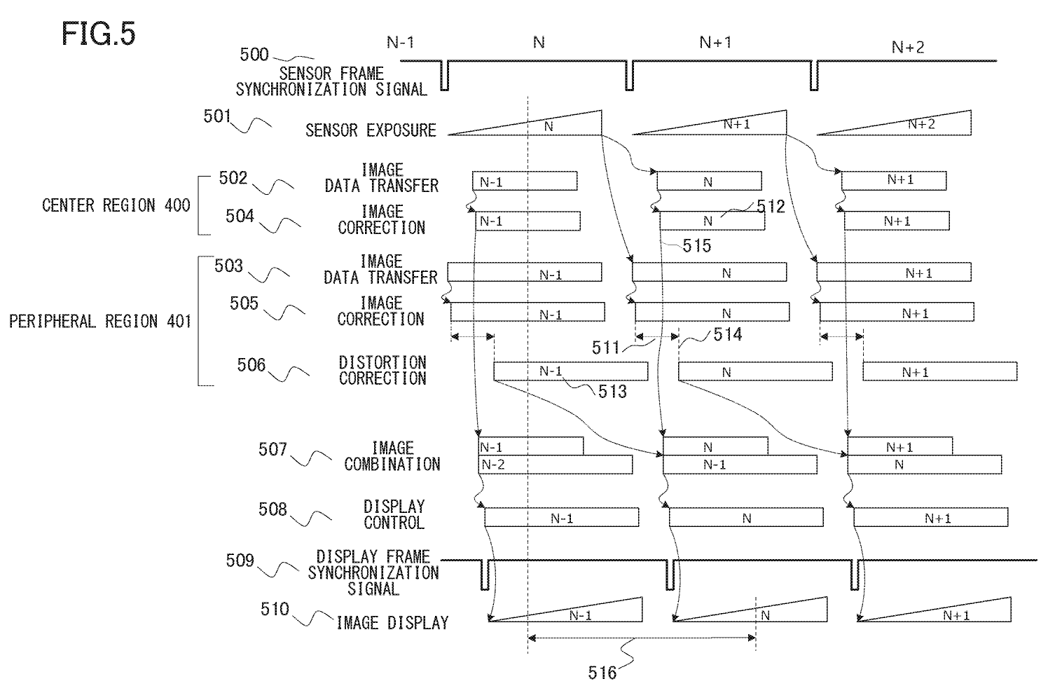

Next, an image data processing procedure executed by the imaging apparatus 100 will be described in time series with reference to FIG. 5. FIG. 5 is a time chart schematically showing timings of steps of processing executed in time series by the respective units. Description will be made in order from the top of the figure.

Notations of N-1, N, N+1, and N+2 shown at the top of the figure indicate an order of image frames captured consecutively. Reference numeral 500 denotes a frame synchronization signal in an imaging operation of the imaging element 111 and corresponds to a preset frame rate. Reference numeral 501 denotes an exposure timing for each frame in the imaging element 111.

Reference numeral 502 denotes a timing at which the image acquisition unit 120 transfers, to the center image processing unit 130, the image data of the center region 400 among the pieces of image data received from the imaging element 111. Reference numeral 503 denotes a timing at which the image acquisition unit 120 transfers, to the peripheral image processing unit 140, the image data of the peripheral region 401 among the pieces of image data received from the imaging element 111.

Reference numeral 504 denotes a timing at which the center image correction unit 131 executes image correction processing on the image data of the center region 400, and reference numeral 505 denotes a timing at which the peripheral image correction unit 141 executes image correction processing on the image data of the peripheral region 401.

Reference numeral 506 denotes a timing at which the distortion correction unit 142 executes the distortion correction processing on the image data of the peripheral region 401 subjected to the image correction processing at the timing 505. Here, reference numeral 511 denotes a delay time from the start of the image correction of the peripheral region 401 at the timing 505 to the start of the distortion correction processing at the timing 506. In other words, reference numeral 511 denotes a time required to perform the image correction on the image data of the peripheral image corresponding to the number of lines including the maximum amount of distortion in the vertical direction and store the corrected image data in the line buffer 200.

Reference numeral 507 denotes a timing at which the image combining unit 150 executes display image combining processing. That is, reference numeral 507 denotes a timing at which the combining processing is executed using the image data of the center region 400 subjected to the image correction at the timing 504 and the image data of the peripheral region 401 subjected to the distortion correction at the timing 506. Here, the image combining unit 150 reads, for input image data 512 of the center region 400, image data 513 of the peripheral region 401 after the distortion correction processing for an immediately preceding frame image from the frame memory 143. Then, the input image data 512 of the center region 400 and the image data 513 of the peripheral region 401 after the distortion correction processing read from the frame memory 143 are combined to generate the display image data of one frame.

In this manner, the image combining unit 150 generates display image data of the N-th frame by using, for example, the image data of the center region 400 of the N-th frame and the image data of the peripheral region of the N-1-th frame, the image data of the peripheral region being subjected to the distortion correction. The display image data of the N-th frame is generated while exposure of the (N+1)-th frame is performed. The combination of the pieces for display image data can be started from the timing 515 at which the output of the image data of the center region 400 of the N-th frame, which is subjected to the image correction, is started, and it is not necessary to wait until the timing 514 at which the image data of the peripheral region of the N-th frame, which is subjected to the distortion correction, is output.

Reference numeral 508 indicates a timing at which the display control unit 160 (FIG. 1) outputs, to the display device 161, the display image data obtained by the combining processing at the timing 507. Reference numeral 509 denotes a frame synchronization signal used to control a timing at which the display device 161 displays the image data for each frame. Reference numeral 510 denotes a timing at which the display device 161 performs image display according to the frame synchronization signal 509. Here, reference numeral 516 denotes a delay time from the imaging timing (a midpoint of a sensor exposure period) for the subject image in the imaging unit 101 to the display timing (a midpoint of a frame display period) for the subject image in the display unit 103.

As described above, in the imaging apparatus 100 according to the present embodiment, the image data is divided into the high-resolution image data of the center region 400 where the visual sensitivity of the user is high and the amount of image distortion is small and the low-resolution image data of the peripheral region 401 in a wide range where the visual sensitivity is low and the amount of image distortion is large, and the image processing is performed on each of the pieces of image data. The distortion correction processing that takes time is executed on the image data of the peripheral region 401. Then, the display image data for the current frame (N) is generated without waiting for completion of the distortion correction processing on the image data of the peripheral region 401 in the captured current frame (N). That is, the image data of the center region 400 of the current frame (N) and the image data of the peripheral region 401 of the preceding frame (N-1) for which the distortion correction processing has been completed are combined to generate the display image data. As a result, the display image generation is not greatly delayed by waiting for the completion of the distortion correction processing for the peripheral region 401 where the visual sensitivity is low. By using the image data of the latest frame (N) for the center region 400 where the visual sensitivity is high, it is possible to reduce the delay time from imaging to the display image generation. A high-resolution image with a small amount of image distortion is displayed without a time lag in the center region 400 of the screen that the user wants to gaze at, and an image subjected to the distortion correction processing is displayed in the peripheral region 401 of the screen where the visual sensitivity is low but which is useful for spatial perception. Since a moving image is smoothly displayed, the user can accurately recognize, for example, the surrounding situation without feeling unnaturalness.

### Second Embodiment

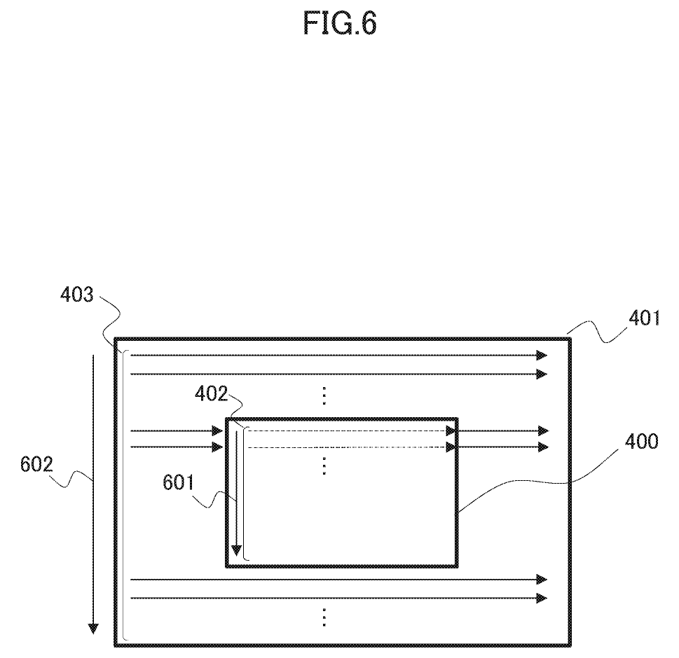

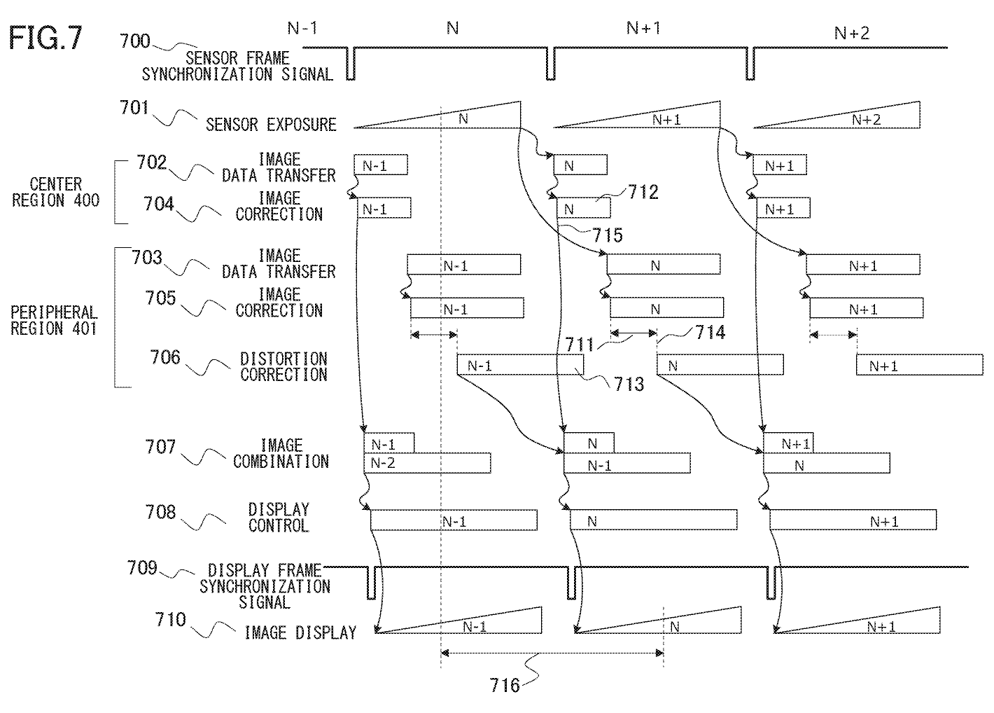

A second embodiment will be described with reference to FIGS. 6 and 7. A description of matters common to the first embodiment will be simplified or omitted. An imaging apparatus of the present embodiment also has the overall configuration shown in FIG. 1 as in the first embodiment.

In the first embodiment, the imaging element 111 transmits the raster-scanned image data to the image acquisition unit 120 line by line. On the other hand, in the second embodiment, an imaging element 111 capable of outputting captured image data in a predetermined order for each region set in advance on an imaging screen is used.

FIG. 6 is a schematic diagram for describing a procedure of separating, by the imaging element 111, the captured image data into image data 402 of a center region 400 and image data 403 of a peripheral region 401 and outputting the image data 402 and the image data 403. A horizontal arrow indicates horizontal scanning in data transfer, and vertical arrows 601 and 602 indicate vertical scanning in the data transfer for respective regions. A predetermined region is registered in advance on a light receiving surface of the imaging element 111. Specifically, the center region 400 and the peripheral region 401 are set and stored in a control unit of the imaging element 111.

The imaging element 111 first outputs the image data 402 (dotted arrow) of the center region 400 among the preset regions to an image acquisition unit 120 line by line while performing vertical scanning in a direction indicated by the arrow 601 from an upper portion of the image. After completing the output of the image data 402 of the center region 400, the imaging element 111 sequentially outputs the image data 403 (solid arrow) of the peripheral region 401 to the image acquisition unit 120 line by line while performing vertical scanning in the direction indicated by the arrow 602 from the upper portion of an image. In the example of FIG. 6, the center region 400 and the peripheral region 401 are set exclusively such that there is no overlapping portion. However, the center region 400 and the peripheral region 401 may be set such that a part of the center region 400 and a part of the peripheral region 401 overlap each other.

Next, an image data processing procedure executed by the imaging apparatus according to the second embodiment will be described in time series with reference to FIG. 7. FIG. 7 is a time chart schematically showing timings of steps of processing executed in time series by the respective units. Description will be made in order from the top of the figure.

Notations of N-1, N, N+1, and N+2 shown at the top of the figure indicate an order of image frames captured consecutively. Reference numeral 700 denotes a frame synchronization signal in an imaging operation of the imaging element 111 and corresponds to a preset frame rate. Reference numeral 701 denotes an exposure timing for each frame in the imaging element 111.

Reference numeral 702 denotes a timing at which the image acquisition unit 120 transfers the image data of the center region 400 received from the imaging element 111 at the beginning of each frame to a center image processing unit 130. Reference numeral 703 denotes a timing at which the image acquisition unit 120 transfers, to a peripheral image processing unit 140, the image data of the peripheral region 401 received from the imaging element 111 after the center region 400.

Reference numeral 704 denotes a timing at which a center image correction unit 131 executes image correction processing on the image data of the center region 400, and reference numeral 705 denotes a timing at which a peripheral image correction unit 141 executes image correction processing on the image data of the peripheral region 401.

Reference numeral 706 denotes a timing at which a distortion correction unit 142 executes distortion correction processing on the image data of the peripheral region 401 subjected to the image correction processing at the timing 705. Here, reference numeral 711 denotes a delay time from the start of the image correction of the peripheral region 401 at the timing 705 to the start of the distortion correction processing at the timing 706. In other words, reference numeral 711 denotes a time required to perform the image correction on the image data of the peripheral image corresponding to the number of lines including the maximum amount of distortion in the vertical direction and store the corrected image data in a line buffer 200.

Reference numeral 707 denotes a timing at which an image combining unit 150 executes display image combining processing. That is, reference numeral 707 denotes a timing at which the combining processing is executed using the image data of the center region 400 subjected to the image correction at the timing 704 and the image data of the peripheral region 401 subjected to the distortion correction at the timing 706. Here, the image combining unit 150 reads, for input image data 712 of the center region 400, image data 713 of the peripheral region 401 after the distortion correction processing for an immediately preceding frame image from a frame memory 143. Then, the input image data 712 of the center region 400 and the image data 713 of the peripheral region 401 after the distortion correction processing read from the frame memory 143 are combined to generate display image data of one frame.

In this manner, the image combining unit 150 generates display image data of the N-th frame by using, for example, the image data of the center region 400 of the N-th frame and the image data of the peripheral region of the N-1-th frame, the image data of the peripheral region being subjected to the distortion correction. The display image data of the N-th frame is generated while exposure of the (N+1)-th frame is performed. The combination of the pieces of display image data can be started from the timing 715 at which the output of the image data of the center region 400 of the N-th frame, which is subjected to the image correction, is started, and it is not necessary to wait until the timing 714 at which the image data of the peripheral region of the N-th frame, which is subjected to the distortion correction, is output.

Reference numeral 708 indicates a timing at which a display control unit 160 (FIG. 1) outputs, to a display device 161, the display image data obtained by the combining processing at the timing 707. Reference numeral 709 denotes a frame synchronization signal used to control a timing at which the display device 161 displays the image data for each frame. Reference numeral 710 denotes a timing at which the display device 161 performs image display according to the frame synchronization signal 709. Here, reference numeral 716 denotes a delay time from an imaging timing (a midpoint of a sensor exposure period) for a subject image in an imaging unit 101 to a display timing (a midpoint of a frame display period) for the subject image in a display unit 103.

As described above, in the imaging apparatus of the present embodiment, the imaging element 111 first outputs the image data of the center region 400, and then outputs the image data of the peripheral region 401 to the image acquisition unit 120, so that a start timing of the image correction processing for the center region 400 can be advanced.

Also in the present embodiment, the display image data for the current frame (N) is generated without waiting for completion of the distortion correction processing on the image data of the peripheral region 401 in the captured current frame (N). That is, the image data of the center region 400 of the current frame (N) and the image data of the peripheral region 401 of the preceding frame (N-1) for which the distortion correction processing has been completed are combined to generate the display image data. As a result, the display image generation is not greatly delayed by waiting for the completion of the distortion correction processing for the peripheral region 401 where the visual sensitivity is low. By using the image data of the latest frame (N) for the center region 400 where the visual sensitivity is high, it is possible to reduce the delay time from imaging to the display image generation. A high-resolution image with a small amount of image distortion is displayed without a time lag in the center region 400 of the screen that the user wants to gaze at, and an image subjected to the distortion correction processing is displayed in the peripheral region 401 of the screen where the visual sensitivity is low but which is useful for spatial perception. Since a moving image is smoothly displayed, the user can accurately recognize, for example, the surrounding situation without feeling unnaturalness.

### Third Embodiment

A third embodiment will be described with reference to the drawings. A description of matters common to the first or second embodiment will be simplified or omitted. In the first embodiment, the center region 400 and the peripheral region 401 are imaged by one imaging unit 101. On the other hand, the third embodiment adopts a configuration in which an imaging unit that images a center region 400 and an imaging unit that images a peripheral region 401 are separately provided, image processing is executed on pieces of image data captured by the respective imaging units, and an image to be displayed is generated by combining the pieces of image data.

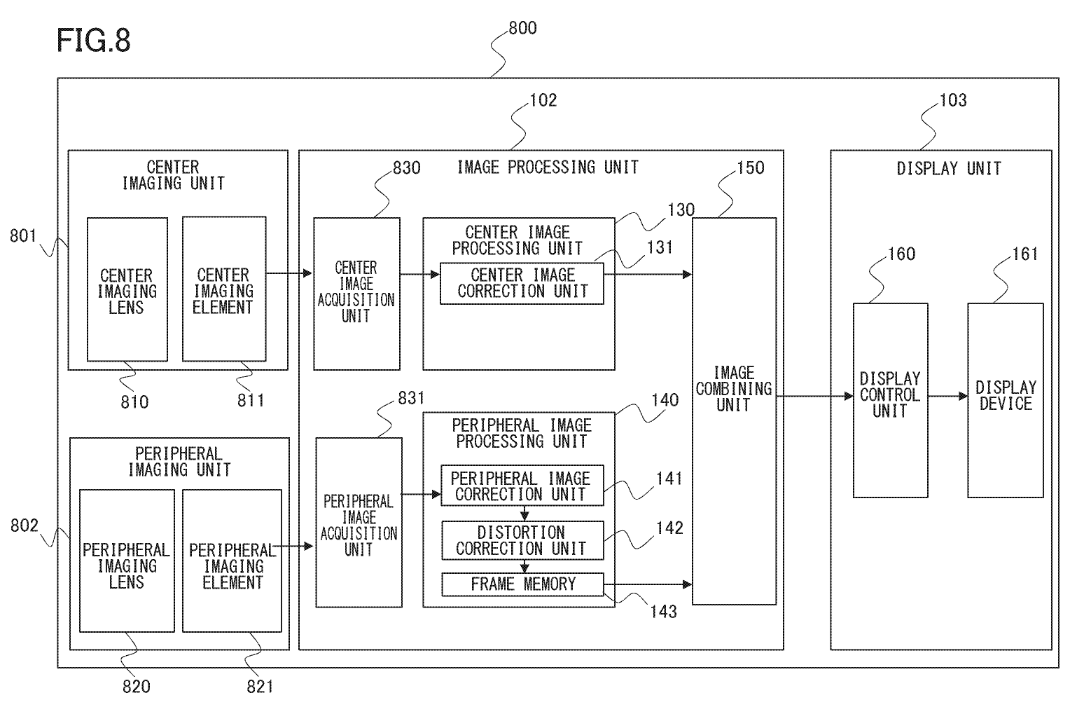

FIG. 8 is a schematic block diagram showing an overall configuration of an imaging apparatus 800 according to the third embodiment. The same functional elements as those in FIG. 1 referred to in the description of the first embodiment are denoted by the same reference numerals, and a detailed description thereof will be omitted. As shown in FIG. 8, the imaging apparatus 800 according to the present embodiment includes a center imaging unit 801 that images the center region 400 of a subject, a peripheral imaging unit 802 that images the peripheral region 401 of the subject, an image processing unit 102, and a display unit 103.

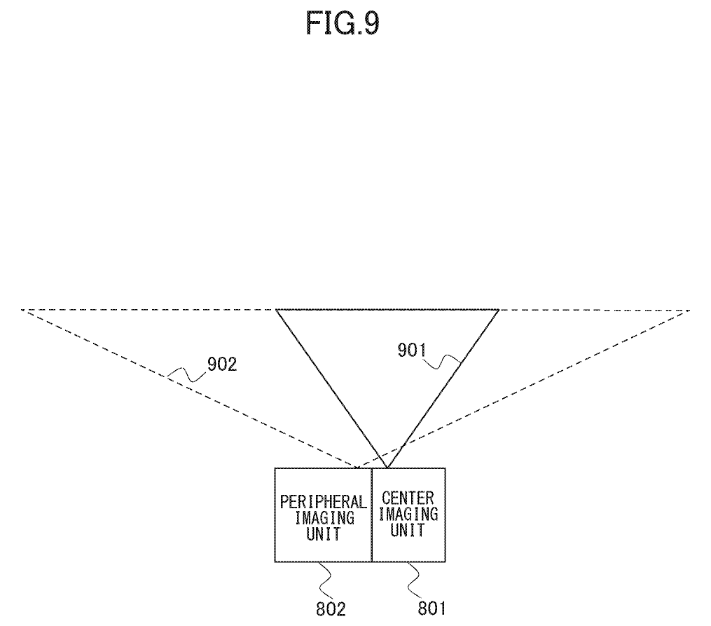

The center imaging unit 801 includes a center imaging lens 810 and a center imaging element 811, and the peripheral imaging unit 802 includes a peripheral imaging lens 820 and a peripheral imaging element 821. FIG. 9 shows view angles at which the center imaging unit 801 and the peripheral imaging unit 802 perform imaging. The center imaging unit 801 images a narrow region 901 near the center of the subject with the center imaging lens 810 having a high imaging magnification. On the other hand, the peripheral imaging unit 802 images a wide peripheral region 902 with the peripheral imaging lens 820 having a low imaging magnification.

The center imaging unit 801 outputs image data of the imaged region to a center image acquisition unit 830 of the image processing unit 102, and the peripheral imaging unit 802 outputs image data of the imaged region to a peripheral image acquisition unit 831 of the image processing unit 102.

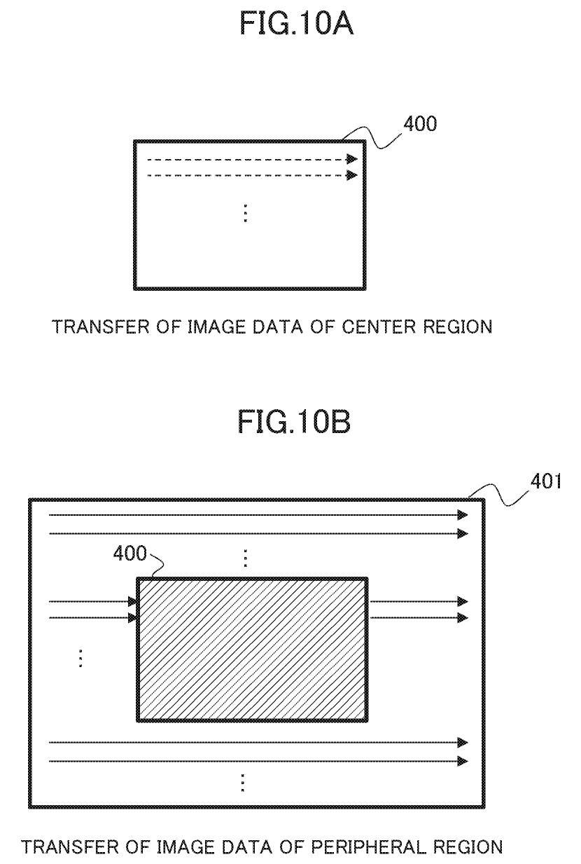

The center image acquisition unit 830 outputs the image data of the center region 400 received from the center imaging unit 801 to a center image processing unit 130 line by line from an upper portion of an image as shown in FIG. 10A.

The peripheral image acquisition unit 831 removes image data of a portion corresponding to the center region 400 from the image data received from the peripheral imaging unit 802, and outputs the image data to a peripheral image processing unit 140 line by line from an upper portion of an image as shown in FIG. 10B. In FIGS. 10A and 10B, the center region 400 and the peripheral region 401 are set exclusively such that there is no overlapping portion. However, the center region 400 and the peripheral region 401 may be set such that a part of the center region 400 and a part of the peripheral region 401 overlap each other. Since the functions of the center image processing unit 130, the peripheral image processing unit 140, an image combining unit 150, and the display unit 103 are similar to those of the first embodiment, the description thereof will be omitted.

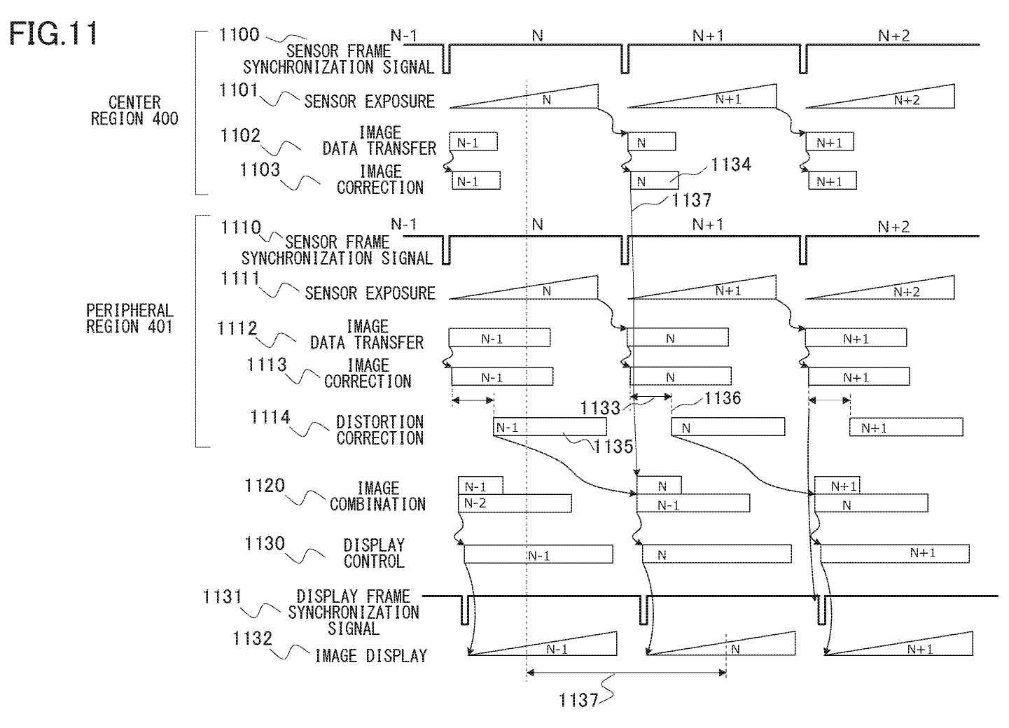

Next, an image data processing procedure executed by the imaging apparatus 800 will be described in time series with reference to FIG. 11. FIG. 11 is a time chart schematically showing timings of steps of processing executed in time series by the respective units. Description will be made in order from the top of the figure.

Notations of N-1, N, N+1, and N+2 shown at the top of the figure indicate an order of image frames captured consecutively.

Reference numeral 1100 denotes a frame synchronization signal in an imaging operation of the center imaging element 811 and corresponds to a preset frame rate. Reference numeral 1101 denotes an exposure timing for each frame in the center imaging element 811.

Reference numeral 1102 denotes a timing at which the center image acquisition unit 830 transfers, to the center image processing unit 130, the image data of the center region 400 received from the center imaging element 811. Reference numeral 1103 denotes a timing at which a center image correction unit 131 executes image correction processing on the image data of the center region 400.

Reference numeral 1110 denotes a frame synchronization signal in an imaging operation of the peripheral imaging element 821 and corresponds to a preset frame rate. Reference numeral 1111 denotes an exposure timing for each frame in the peripheral imaging element 821.

Reference numeral 1112 denotes a timing at which the peripheral image acquisition unit 831 transfers, to the peripheral image processing unit 140, the image data of the peripheral region 401 received from the peripheral imaging element 821. Reference numeral 1113 denotes a timing at which a peripheral image correction unit 141 executes image correction processing on the image data of the peripheral region 401. Reference numeral 1114 denotes a timing at which a distortion correction unit 142 executes distortion correction processing on the image data of the peripheral region 401 subjected to image correction at the timing 1113.

Here, reference numeral 1133 denotes a delay time from the start of the image correction processing on the image data of the peripheral region 401 at the timing 1113 to the start of the distortion correction processing at the timing 1114. In other words, reference numeral 1133 denotes a time required to perform the image correction on the image data of the peripheral image corresponding to the number of lines including the maximum amount of distortion in the vertical direction and store the corrected image data in a line buffer 200.

Reference numeral 1120 denotes a timing at which the image combining unit 150 executes display image combining processing. That is, reference numeral 1120 denotes a timing at which the combining processing is executed using the image data of the center region 400 subjected to the image correction at the timing 1103 and the image data of the peripheral region 401 subjected to the distortion correction at the timing 1114. Here, the image combining unit 150 reads, for input image data 1134 of the center region 400, image data 1135 of the peripheral region 401 after the distortion correction processing for an immediately preceding frame image from a frame memory 143. Then, the input image data 1134 of the center region 400 and the image data 1135 of the peripheral region 401 after the distortion correction processing read from the frame memory 143 are combined to generate display image data of one frame.

In this manner, the image combining unit 150 generates display image data of the N-th frame by using, for example, the image data of the center region 400 of the N-th frame and the image data of the peripheral region of the N-1-th frame, the image data of the peripheral region being subjected to the distortion correction. The display image data of the N-th frame is generated while exposure of the (N+1)-th frame is performed. The combination of the pieces of display image data can be started from the timing 1137 at which the output of the image data of the center region 400 of the N-th frame, which is subjected to the image correction, is started, and it is not necessary to wait until the timing 1136 at which the image data of the peripheral region of the N-th frame, which is subjected to the distortion correction, is output.

Reference numeral 1130 indicates a timing at which a display control unit 160 (FIG. 1) outputs, to a display device 161, the display image data obtained by the combining processing at the timing 1120. Reference numeral 1131 denotes a frame synchronization signal used to control a timing at which the display device 161 displays the image data for each frame. Reference numeral 1132 denotes a timing at which the display device 161 performs image display according to the frame synchronization signal 1131. Here, reference numeral 1137 denotes a delay time from an imaging timing (a midpoint of a sensor exposure period) for a subject image in an imaging unit 101 to a display timing (a midpoint of a frame display period) for the subject image in the display unit 103.

As described above, in the imaging apparatus of the third embodiment, the imaging units that respectively capture the subject images of the center region 400 and the peripheral region 401 are provided, and the steps of image processing for the respective regions are executed in parallel, so that a start timing of the image correction processing for the center region 400 can be advanced.

Also in the present embodiment, the display image data for the current frame (N) is generated without waiting for completion of the distortion correction processing on the image data of the peripheral region 401 in the captured current frame (N). That is, the image data of the center region 400 of the current frame (N) and the image data of the peripheral region 401 of the preceding frame (N-1) for which the distortion correction processing has been completed are combined to generate the display image data. As a result, the display image generation is not greatly delayed by waiting for the completion of the distortion correction processing for the peripheral region 401 where the visual sensitivity is low. By using the image data of the latest frame (N) for the center region 400 where the visual sensitivity is high, it is possible to reduce the delay time from imaging to the display image generation. A high-resolution image with a small amount of image distortion is displayed without a time lag in the center region 400 of the screen that the user wants to gaze at, and an image subjected to the distortion correction processing is displayed in the peripheral region 401 of the screen where the visual sensitivity is low but which is useful for spatial perception. Since a moving image is smoothly displayed, the user can accurately recognize, for example, the surrounding situation without feeling unnaturalness.

### Fourth Embodiment

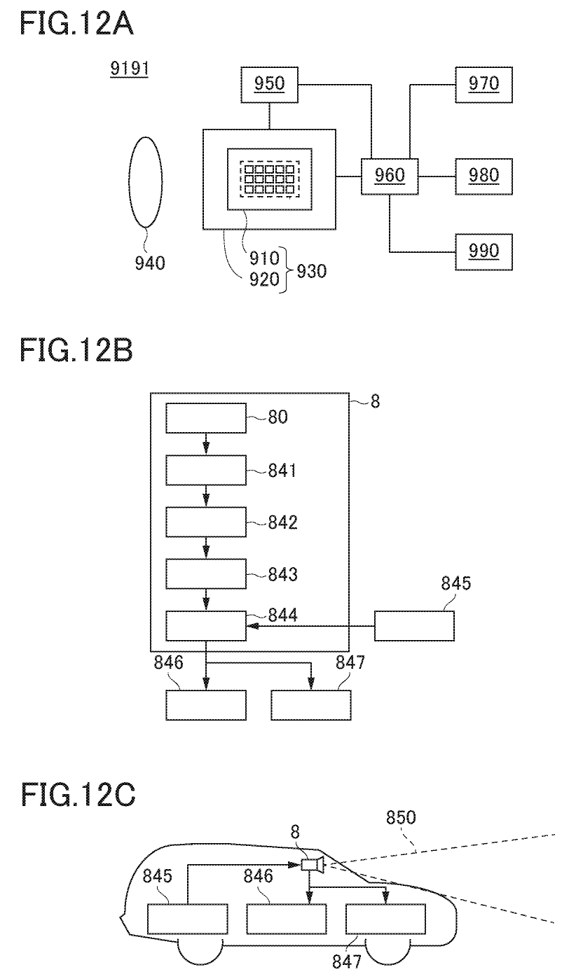

As a fourth embodiment, equipment including the imaging apparatus (semiconductor apparatus) according to any one of the above-described embodiments will be described. FIG. 12A is a schematic diagram for describing equipment 9191 including an imaging apparatus 930 (semiconductor apparatus) according to the above-described embodiment. The equipment 9191 including the imaging apparatus 930 will be described in detail.

The imaging apparatus 930 is the imaging apparatus according to any one of the first to third embodiments. The imaging apparatus 930 may include a semiconductor device 910 and a package 920 that houses the semiconductor device 910. The package 920 can include a base to which the semiconductor device 910 is fixed and a lid such as glass that faces the semiconductor device 910. The package 920 can further include a bonding member such as a bonding wire or a bump that connects a terminal provided on the base and a terminal provided on the semiconductor device 910.

The equipment 9191 can include at least one of an optical apparatus 940, a control apparatus 950, a processing apparatus 960, a display apparatus 970, a storage apparatus 980, and a mechanical apparatus 990. The optical apparatus 940 is, for example, a lens, a shutter, or a mirror provided corresponding to the imaging apparatus 930. The control apparatus 950 controls the imaging apparatus 930. The control apparatus 950 is, for example, a semiconductor apparatus such as an application specific integrated circuit (ASIC).

The processing apparatus 960 processes a signal output from the imaging apparatus 930. The processing apparatus 960 is a semiconductor apparatus such as a central processing unit (CPU) or an ASIC for configuring a digital front end (DFE). The display apparatus 970 is an EL display apparatus or a liquid crystal display apparatus that displays information (image) obtained by the imaging apparatus 930. The storage apparatus 980 is a magnetic device or a semiconductor device that stores information (image) obtained by the imaging apparatus 930. The storage apparatus 980 is a volatile memory such as a static random-access memory (SRAM) or a dynamic random-access memory (DRAM), or a nonvolatile memory such as a flash memory or a hard disk drive.

The mechanical apparatus 990 includes a movable unit or a propulsion unit such as a motor or an engine. In the equipment 9191, a signal output from the imaging apparatus 930 is displayed on the display apparatus 970 or is transmitted to the outside by a communication apparatus (not shown) included in the equipment 9191. Therefore, the equipment 9191 may further include the storage apparatus 980 and the processing apparatus 960 separately from a storage circuit and an arithmetic circuit of the imaging apparatus 930. The mechanical apparatus 990 may be controlled based on a signal output from the imaging apparatus 930.

Furthermore, the equipment 9191 is suitable for electronic equipment such as an information terminal (for example, a smartphone or a wearable terminal) having an imaging function or a camera (for example, an interchangeable lens camera, a compact camera, a video camera, or a surveillance camera). The mechanical apparatus 990 in the camera can drive components of the optical apparatus 940 for zooming, focusing, and shutter operations. Alternatively, the mechanical apparatus 990 in the camera can move the imaging apparatus 930 for a vibration-proof operation.

Furthermore, the equipment 9191 may be transportation equipment such as a vehicle, a ship, or a flying body. The mechanical apparatus 990 in the transportation equipment can be used as a movement apparatus. The equipment 9191 serving as the transportation equipment is suitable for transporting the imaging apparatus 930 and assisting and/or automating driving (steering) by the imaging function. The processing apparatus 960 for assisting and/or automating the driving (steering) can perform processing for operating the mechanical apparatus 990 serving as the movement apparatus based on information obtained by the imaging apparatus 930. Alternatively, the equipment 9191 may be medical equipment such as an endoscope, measurement equipment such as a distance measurement sensor, analytical equipment such as an electron microscope, office equipment such as a copying machine, or industrial equipment such as a robot. According to the above-described embodiment, it is possible to stably acquire an image obtained by effectively correcting a distortion of a captured image without excessively increasing a time required from imaging to display.

Therefore, if the imaging apparatus 930 according to the present embodiment is used for the equipment 9191, the value of the equipment can also be improved. For example, it is possible to obtain excellent performance when the imaging apparatus 930 is mounted on the transportation equipment and performs imaging of the outside of the transportation equipment or measurement of an external environment. Therefore, in manufacturing and selling the transportation equipment, it is advantageous to determine to mount the semiconductor apparatus according to the present embodiment on the transportation equipment in order to enhance the performance of the transportation equipment itself. In particular, the imaging apparatus 930 is suitable for transportation equipment that performs driving assistance and/or automated driving of the transportation equipment by using information obtained by the semiconductor apparatus. Implementation in a vehicle, a ship, a flying body, and the like is not limited to application to equipment practically used for transportation purposes, and can be suitably applied to, for example, a drone or the like that performs aerial imaging for various purposes including inspection of buildings and agricultural facilities, monitoring of natural phenomena, and the like.

A photoelectric conversion system and a mobile body according to the present embodiment will be described with reference to FIGS. 12B and 12C. FIG. 12B shows an example of the photoelectric conversion system related to an in-vehicle camera. A photoelectric conversion system 8 includes a photoelectric conversion apparatus 80. The photoelectric conversion apparatus 80 is the photoelectric conversion apparatus 100 serving as an electronic component included in the imaging apparatus described in the above-described embodiment. The photoelectric conversion system 8 includes an image processing unit 841 (image generation unit 7) that performs image processing on a plurality of pieces of image data acquired by the photoelectric conversion apparatus 100, and a parallax acquisition unit 842 (phase difference detection unit 62) that calculates a parallax (a phase difference of a parallax image) from the plurality of pieces of image data acquired by the photoelectric conversion system 8. Furthermore, the photoelectric conversion system 8 includes a distance acquisition unit 843 that calculates a distance to a target object based on the calculated parallax, and a collision determination unit 844 that determines whether or not there is a possibility of collision based on the calculated distance. Here, the parallax acquisition unit 842 and the distance acquisition unit 843 are examples of a distance information acquisition unit that acquires distance information to the target object. That is, the distance information is information regarding the parallax, a defocus amount, the distance to the target object, and the like. The collision determination unit 844 may determine the possibility of collision by using any one of these pieces of distance information. The distance information acquisition unit may be implemented by dedicated hardware or may be implemented by a software module. Alternatively, the distance information acquisition unit may be implemented by a field programmable gate array (FPGA), an application specific integrated circuit (ASIC), or the like.

The photoelectric conversion system 8 is connected to a vehicle information acquisition apparatus 845, and can acquire vehicle information such as a vehicle speed, a yaw rate, and a steering angle. In addition, the photoelectric conversion system 8 is connected to a control electronic control unit (ECU) 846 which is a control apparatus that outputs a control signal for generating a braking force on the vehicle based on a determination result of the collision determination unit 844. The photoelectric conversion system 8 is also connected to a warning apparatus 847 that issues a warning to a driver based on the determination result of the collision determination unit 844. For example, in a case where the determination result of the collision determination unit 844 indicates that the possibility of collision is high, the control ECU 846 performs vehicle control to avoid collision and reduce damage by applying a brake, returning an accelerator, reducing an engine output, or the like. The warning apparatus 847 issues a warning to a user by emitting warnings such as sound, displaying warning information on a screen of a car navigation system or the like, providing vibrations to a seat belt or a steering wheel, or the like.

In the present embodiment, the photoelectric conversion system 8 images the periphery of the vehicle, for example, an area in front of or behind the vehicle. FIG. 12C shows the photoelectric conversion system in the case of imaging the area (imaging range 850) in front of the vehicle. The vehicle information acquisition apparatus 845 sends an instruction to the photoelectric conversion system 8 or the photoelectric conversion apparatus 80. With such a configuration, accuracy of distance measurement can be further improved.

In the above description, an example of performing control to prevent collision with another vehicle has been described, but the present technology is also applicable to control for performing automated driving following another vehicle, control for performing automated driving so as not to stray from a lane, and the like. Furthermore, the photoelectric conversion system is not limited to the vehicle such as a car, and can be applied to a mobile body (mobile apparatus) such as a ship, an aircraft, or an industrial robot, for example. In addition, the present technology can be applied not only to a mobile body but also to equipment that widely uses object recognition, such as an intelligent transport system (ITS).

With the photoelectric conversion apparatus according to the above-described embodiment, a high-resolution image with a small amount of image distortion is displayed without a time lag in the center region of the screen that the user wants to gaze at, and an image subjected to the distortion correction processing is displayed in the peripheral region of the screen where the visual sensitivity is low but which is useful for spatial perception. Therefore, a moving image is smoothly displayed, and the user can thus accurately recognize, for example, the surrounding situation in the mobile body without feeling unnaturalness, which can contribute to improvement of safety and the like.

The equipment according to the present embodiment can include at least one of an optical apparatus corresponding to the imaging apparatus according to any one of the above-described embodiments, a control apparatus that controls the imaging apparatus, and a processing apparatus that processes information obtained from the imaging apparatus. Alternatively, at least one of the display apparatus that displays information obtained from the imaging apparatus, the storage apparatus that stores information obtained from the imaging apparatus, and the mechanical apparatus that operates based on information obtained from the imaging apparatus can be included.

### Other Embodiments

The present disclosure is not limited to the embodiments and examples described above, and many modifications can be made within the technical idea of the present disclosure. For example, all or some of the different embodiments described above may be combined and implemented.

For example, in the first to third embodiments, the distortion correction processing is executed only on the image data of the peripheral region 401 having a large amount of distortion. However, the distortion correction processing may also be executed on the image data of the center region 400 having a small amount of distortion in order to improve image quality of a region boundary. In this case, since the amount of distortion of the center region 400 is small, a delay time from the start of the image correction processing to the start of the distortion correction processing is much shorter than that for the peripheral region 401. Therefore, similarly to the first to third embodiments, image combination with the image data of the peripheral region 401 of the preceding frame (N-1) for which distortion correction has been performed is performed according to the output of the image data of the center region 400 of the current frame (N), which is subjected to the distortion correction, so that the start of image combination can be advanced. As a result, it is possible to reduce the delay time from imaging to display.

Furthermore, the imaging apparatus according to the present disclosure is not limited to the application to the wearable device such as the HMD, and can also be applied by being mounted on a vehicle, for example, to display image data obtained by imaging the surroundings of the vehicle, or to recognize a surrounding object, as described in the fourth embodiment. In this case, it is possible to reduce a time required from imaging of the surrounding object to display of the image data on the display device, and it is possible to reduce a time taken to recognize a front object by reducing a time taken to prepare the image data used for recognition processing.

The application of the imaging apparatus described in each embodiment is not limited to imaging. For example, the imaging apparatus described in the embodiment is also applicable to a distance measurement apparatus (a distance measurement apparatus using focus detection, time of flight (TOF), or the like), a photometric apparatus (an apparatus for measuring an incident light quantity or the like), or the like.

The photoelectric conversion apparatus used in the imaging apparatus according to the present disclosure is not limited to a specific form, and may be, for example, any one of a front-illuminated type sensor and a back-illuminated type sensor. Alternatively, the photoelectric conversion apparatus may be a stacked-type photoelectric conversion apparatus in which a semiconductor chip including a light receiving unit and a semiconductor chip including an electric circuit such as a logic circuit are stacked.

The present technology can also be implemented by processing in which a program for implementing one or more functions of the embodiments is supplied to a system or a device via a network or a storage medium, and one or more processors in a computer of the system or the device read and execute the program. The present disclosure can also be implemented by a circuit (for example, an application specific integrated circuit (ASIC)) that implements one or more functions. A computer-readable recording medium in which the program is recorded is also included in the embodiment.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-033590, filed Mar. 4, 2025, which is hereby incorporated by reference herein in its entirety.

What is claimed is:

1. An imaging apparatus comprising:
an imaging unit configured to sequentially output a first frame image and a second frame image, the first frame image and the second frame image being obtained by continuously capturing an optical image incident through an imaging optical system;
a first image processing unit configured to execute image processing on image data of a first region of each frame image output by the imaging unit;
a second image processing unit configured to execute image processing on image data of a second region of the each frame image output by the imaging unit; and
an image combining unit configured to combine the image data of the first region processed by the first image processing unit and the image data of the second region processed by the second image processing unit, wherein
a time required for the image processing per frame image is longer in the second image processing unit than in the first image processing unit, and
the image combining unit is configured to combine a result of executing the image processing on the second frame image by the first image processing unit and a result of executing the image processing on the first frame image by the second image processing unit to generate a corrected frame image.

2. The imaging apparatus according to claim 1, wherein the second region is a region in which an amount of distortion due to distortion aberration of the imaging optical system is larger than an amount of distortion in the first region.

3. The imaging apparatus according to claim 1, wherein
the image data of the first region is image data obtained by capturing an image within a range of a predetermined view angle centered on an optical axis of the imaging optical system, and
the image data of the second region includes image data obtained by capturing an image corresponding to a range of a view angle larger than the predetermined view angle.

4. The imaging apparatus according to claim 1, wherein the image processing executed by the second image processing unit includes distortion correction processing of correcting a distortion of an image.

5. The imaging apparatus according to claim 4, wherein the second image processing unit includes a buffer memory for storing image data corresponding to a number of lines to be used for performing the distortion correction processing.

6. The imaging apparatus according to claim 1, further comprising an image acquisition unit configured to acquire the each frame image from the imaging unit,
wherein the image acquisition unit is configured to transmit the image data of the first region to the first image processing unit and transmits the image data of the second region to the second image processing unit.

7. The imaging apparatus according to claim 6, wherein the imaging unit is configured to output the image data to the image acquisition unit according to an arrangement of pixels in a case of outputting the each frame image.

8. The imaging apparatus according to claim 6, wherein the imaging unit is configured to sequentially output the image data of the first region and the image data of the second region to the image acquisition unit in a case of outputting the each frame image.

9. The imaging apparatus according to claim 1, wherein
the imaging optical system includes a center imaging lens having a small view angle and a peripheral imaging lens having a large view angle,
the imaging unit includes a center imaging element configured to capture a light image incident through the center imaging lens, and a peripheral imaging element configured to capture a light image incident through the peripheral imaging lens,
a frame image output from the center imaging element is processed by the first image processing unit, and
a frame image output from the peripheral imaging element is processed by the second image processing unit.

10. The imaging apparatus according to claim 9, further comprising:
a center image acquisition unit configured to acquire the frame image from the center imaging element; and a peripheral image acquisition unit configured to acquire the frame image from the peripheral imaging element, wherein
the center image acquisition unit is configured to transmit the image data of the first region to the first image processing unit, and
the peripheral image acquisition unit is configured to transmit the image data of the second region to the second image processing unit.

11. The imaging apparatus according to claim 1, wherein
the second image processing unit includes a frame memory configured to store a processing result, and
the image combining unit is configured to combine a processing result for the second frame image processed by the first image processing unit and a processing result for the first frame image processed by the second image processing unit, the processing result for the first frame image being stored in the frame memory.

12. The imaging apparatus according to claim 1, wherein the image combining unit is configured to output the corrected frame image to a display apparatus.

13. An imaging method comprising:
an imaging step of sequentially outputting, by an imaging unit, a first frame image and a second frame image, the first frame image and the second frame image being obtained by continuously capturing an optical image incident through an imaging optical system;
a first image processing step of executing, by a first image processing unit, image processing on image data of a first region of each frame image output by the imaging unit;
a second image processing step of executing, by a second image processing unit, image processing on image data of a second region of the each frame image output by the imaging unit; and
an image combining step of combining, by an image combining unit, the image data of the first region processed by the first image processing unit and the image data of the second region processed by the second image processing unit, wherein
a time required for the image processing per frame image is longer in the second image processing step than in the first image processing step, and
in the image combining step, a result of executing the image processing on the second frame image by the first image processing unit and a result of executing the image processing on the first frame image by the second image processing unit are combined to generate a corrected frame image.

14. The imaging method according to claim 13, wherein the second region is a region in which an amount of distortion due to distortion aberration of the imaging optical system is larger than an amount of distortion in the first region.

15. The imaging method according to claim 13, wherein
the image data of the first region is image data obtained by capturing an image within a range of a predetermined view angle centered on an optical axis of the imaging optical system, and
the image data of the second region includes image data obtained by capturing an image corresponding to a range of a view angle larger than the predetermined view angle.

16. The imaging method according to claim 13, further comprising an image acquisition step of acquiring, by an image acquisition unit, the each frame image from the imaging unit, transmitting the image data of the first region to the first image processing unit, and transmitting the image data of the second region to the second image processing unit.

17. The imaging method according to claim 16, wherein the imaging unit is configured to output the image data to the image acquisition unit according to an arrangement of pixels in a case of outputting the each frame image.

18. The imaging method according to claim 16, wherein the imaging unit is configured to sequentially output the image data of the first region and the image data of the second region to the image acquisition unit in a case of outputting the each frame image.

19. The imaging method according to claim 13, wherein the image processing executed by the second image processing unit includes distortion correction processing of correcting a distortion of an image.

20. A computer-readable recording medium recording a program for causing a computer to control each step of the imaging method according to claim 13.
